(19) United States
(12) Patent Application Publication
(10) Pub. No.: US 2026/0149573 A1
(43) Pub. Date: May 28, 2026

(54) BATTERY UNIT PROTECTION METHOD AND BATTERY SYSTEM

(71) Applicant: Nanjing Silergy Micro Technology Co., Ltd., Nanjing (CN)

(72) Inventors: Lei Zhang, Nanjing (CN); Sihua Wen, Nanjing (CN)

(21) Appl. No.: 19/395,138

(22) Filed: Nov. 20, 2025

(30) Foreign Application Priority Data
Nov. 26, 2024 (CN) 202411717262.X

(51) Int. Cl. H04L 9/08; H04L 9/32

(52) U.S. Cl. CPC H04L 9/0825; H04L 9/0869; H04L 9/3247

(57) ABSTRACT

A method of battery unit protection, and when a first chip in a battery unit matches with a host, the method can include: converting by the host, a first signal into a first ciphertext according to a symmetric encryption algorithm and a temporary shared key; sending, by the host, the first ciphertext to the first chip, where the first signal is configured as a signal generated based on a random number and a plaintext comprising a first command; receiving, by the first chip, the first ciphertext; converting, by the first chip, the first ciphertext into the plaintext comprising the first command according to the symmetric encryption algorithm and the temporary shared key; and executing, by the first chip, the first command to enter a first operating mode.

### RELATED APPLICATIONS

This application claims the benefit of Chinese Patent Application No. 202411717262.X, filed on Nov. 26, 2024, which is incorporated herein by reference in its entirety.

### FIELD OF THE INVENTION

The present invention generally relates to the field of power electronics, and more particularly to battery unit protection methods and battery systems.

### BACKGROUND

Most electronic products on the market, such as mobile phones, tablets, and notebooks, etc., may deteriorate the performance of batteries in electronic products after a period of use, so it is necessary to replace the batteries. Because officially certified batteries (e.g., legitimate batteries) are relatively expensive, many third parties provide uncertified batteries (e.g., illegitimate batteries) on the market. As such, many electronic products employ battery unit protection schemes to protect the product from damage due to substandard batteries.

### BRIEF DESCRIPTION OF THE DRAWINGS

FIG. 1 is a schematic block diagram of an example method for switching operating modes of a first chip, in accordance with embodiments of the present invention.

FIG. 2 is a flow diagram of an example battery unit protection method, in accordance with embodiments of the present invention.

FIG. 3 is a flow diagram of an example method for determining whether a first chip matches a host, in accordance with embodiments of the present invention.

FIG. 4 is a flow diagram of an example information encryption method, in accordance with embodiments of the present invention.

FIG. 5 is a schematic block diagram of an example method for generating a first ciphertext, in accordance with embodiments of the present invention.

FIG. 6 is a schematic block diagram of an example method for decrypting a first ciphertext, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

In some battery unit protection schemes, the main control module (e.g., the host) of the electronic product may only identify whether a gauge chip is legitimate. After authentication, the information exchange between the host and the gauge chip can be completely exposed on the communication cables. Consequently, third parties can successfully deceive the host by replacing only the battery cell of the original battery while retaining the mainboard, e.g., including the gauge chip, from the original battery. Further, by capturing information on the communication cables and modifying parameters of the gauge chip, such as the charge cycle count, the illegitimate batteries provided by third parties can be used in the aforementioned electronic products. Although illegitimate batteries provided by third parties are low-cost, they can pose safety risks. Therefore, there is a need to provide a battery unit protection method to prevent illegitimate batteries that involve only replacing the battery cell from being misjudged as legitimate batteries.

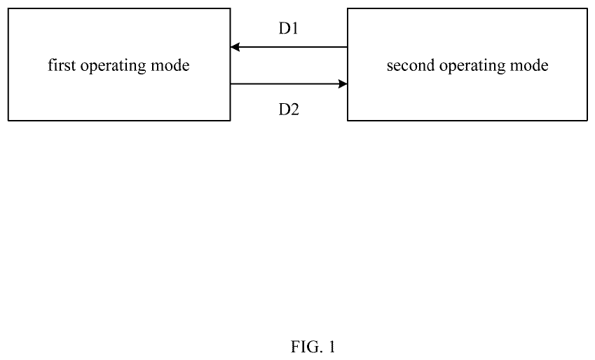

Referring now to FIG. 1, shown is a schematic block diagram of an example method for switching operating modes of a first chip, in accordance with embodiments of the present invention. In this particular example, when the first chip in the battery unit receives first command D1 sent by the host, the operating mode of the first chip can switch from a second operating mode to a first operating mode; and when the first chip receives second command D2, the operating mode of the first chip can switch from the first operating mode to the second operating mode. Optionally, second command D2 may be sent by the host. The second operating mode can be the default operating mode of the first chip, and the first operating mode may have higher permissions than the second operating mode. When the first chip operates in the first operating mode, the host can be allowed to modify battery-related information in the first chip, such as charge-discharge cycle count.

The first chip in the battery unit can be configured as a chip with communication functionality. In one example, the first chip can be configured as a gauge chip. In the second operating mode, the gauge chip can be used to read information of the battery cell in the battery unit (e.g., voltage, temperature, etc.). In the first operating mode, the host can be allowed to modify battery-related information in the gauge chip. Optionally, in the first operating mode, the gauge chip can also read information of the battery cell.

In another example, the first chip can be configured as a battery passport chip. In the second operating mode, the battery passport chip can acquire information of the battery cell in the battery unit (e.g., voltage, temperature, etc.). In the first operating mode, the host can be allowed to modify battery-related information in the battery passport chip. Optionally, in the first operating mode, the battery passport chip can acquire information of the battery cell in the battery unit.

In yet another example, the first chip can be configured as a Battery Management System (BMS) controller chip. In the second operating mode, the BMS controller chip can read information of the battery cell in the battery unit (e.g., voltage, temperature, etc.). In the first operating mode, the host can be allowed to modify battery-related information in the BMS controller chip. Optionally, in the first operating mode, the BMS controller chip can also read information of the battery cell.

In one embodiment, the battery unit can include a mainboard and a battery cell, where the mainboard can include the first chip. In one embodiment, the battery cell and the first chip can be encapsulated within a single battery pack. In another embodiment, the battery cell and the first chip may not be encapsulated together, e.g., they are separate modules. In one embodiment, the first chip and the host can communicate via an I²C bus or an SMBUS bus.

When only the battery cell of the battery unit is replaced, if the host does not modify the battery-related information in the first chip, such as the charge cycle count, the host may not recognize the battery with the replaced battery cell as a new battery. This can lead to short battery life, unstable power supply, failure to supply power when battery limits are reached, potential on-screen prompts from the host, or even unexpected shutdowns. That is, even if a new battery cell is installed, without modifying the battery-related information in the first chip, the new battery cell may not be used normally. Therefore, successfully implementing a solution involving only replacing the battery cell requires the first chip to enter the first operating mode to modify the battery-related information stored within the first chip.

To prevent an illegitimate battery (e.g., a non-officially certified battery) formed by replacing only the battery cell of the battery unit from being misjudged as a legitimate battery (e.g., an officially certified battery), it can be necessary to at least encrypt first command D1. This may prevent the first chip in a third-party battery unit from entering the first operating mode, thereby preventing the host from modifying the battery-related information in the first chip, and ultimately avoiding misjudging the illegitimate battery (with only the battery cell replaced) as a legitimate battery.

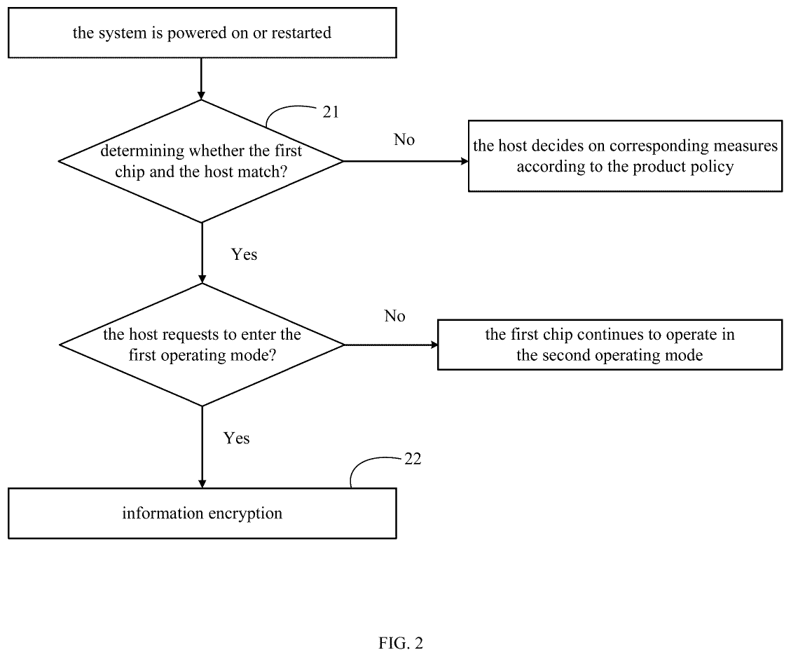

Referring now to FIG. 2, shown is a flow diagram of an example battery unit protection method, in accordance with embodiments of the present invention. The battery unit protection method can include identity authentication and information encryption. In this particular example, optionally, step 21 can be performed when the system is powered on or restarted.

The battery unit protection method can also include, at step 21: Identity Authentication, e.g., determining whether the first chip and the host match. If the first chip and the host match, optionally, step 22 can be executed each time the host requests to enter the first operating mode. If the host does not request to enter the first operating mode, the first chip can continue to operate in the second operating mode. Optionally, if the first chip and the host do not match, the battery unit can be judged as illegitimate. After the host determines the battery unit is illegitimate, the host may decide on corresponding measures according to the product policy.

In one embodiment, the corresponding measures can be pre-set. In one embodiment, after the host determines the battery unit is illegitimate, the first chip may not operate. In another embodiment, when the host is a mobile phone, after the host determines the battery unit is illegitimate, the phone screen can turn black. In yet another embodiment, when the host is a notebook or tablet, after the host determines the battery unit is illegitimate, the battery unit can be allowed to discharge but not charge. In one embodiment, if the first chip and the host match, this can indicate that the first chip is an officially certified chip; and if they do not match, this can indicate that the first chip is a non-officially certified chip. Optionally, determining whether the first chip and the host match may be based on a digital signature algorithm based on an asymmetric encryption algorithm.

The digital signature algorithm can be based on any suitable asymmetric encryption algorithm in certain embodiments. In particular embodiments, the digital signature algorithm can be based on the ECC algorithm, e.g., the digital signature algorithm based on the asymmetric encryption algorithm can be configured as the ECDSA algorithm. At step 22: Information Encryption, can be used to prevent the battery-related information in the first chip from being illegally tampered with when the first chip from enters the first operating mode.

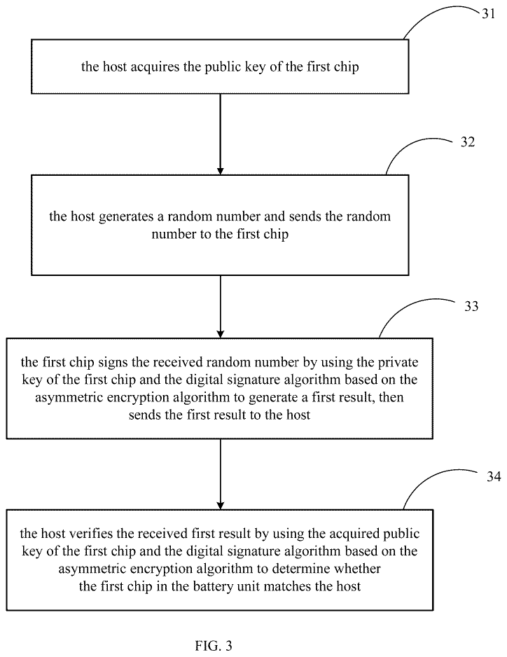

Referring now to FIG. 3, shown is a flow diagram of an example method for determining whether a first chip matches a host, in accordance with embodiments of the present invention. In this particular example, determining whether the first chip and the host match according to a digital signature algorithm based on an asymmetric encryption algorithm can include the following steps. At step 31, the host can acquire the public key of the first chip from a certificate of the first chip.

In particular embodiments, the host may send a command to the first chip to acquire the certificate. The first chip can send its own certificate to the host. The host may verify the certificate using its own public key and the digital signature algorithm based on the asymmetric encryption algorithm, and if the verification is successful, the host can acquire the public key of the first chip from the certificate.

The certificate as described herein may also be referred to as a public key certificate, which is a digital certificate used to verify the holder's identity and associate its public key to ensure the security of communication and data exchange. The certificate can be signed by a CA (Certificate Authority, a trusted third party), and the certificate content can include the holder's public key and related information.

At step 32, the host may generate a random number and sends the random number to the first chip. At step 33, the first chip can use its own private key and the digital signature algorithm based on the asymmetric encryption algorithm to sign the received random number, thereby generating a first result, and then the first chip can send the first result to the host. At step 34, the host may use the acquired public key of the first chip and the digital signature algorithm based on the asymmetric encryption algorithm to verify the signature of the received first result, thereby determining whether the first chip in the battery unit matches the host. Further, if the signature verification is successful, this may indicate that the first chip and the host match, and if unsuccessful, this may indicate that they do not match.

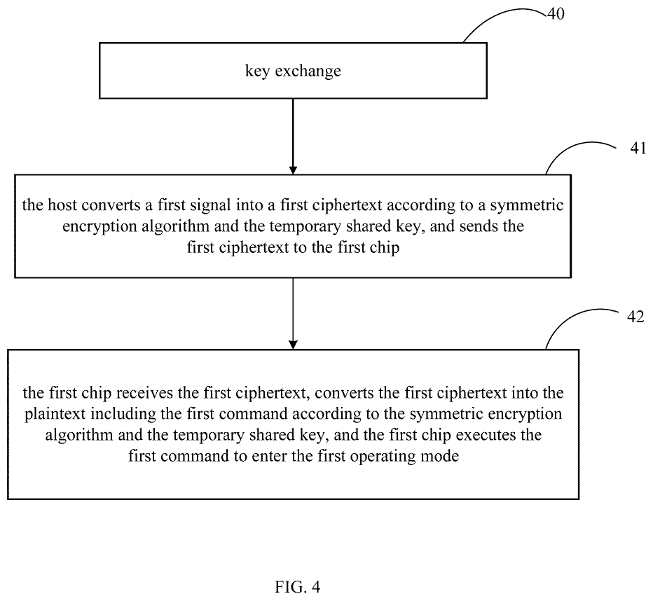

Referring now to FIG. 4, shown is a flow diagram of an example information encryption method, in accordance with embodiments of the present invention. In this particular example, the information encryption method can include the following steps. At step 40, Key Exchange, the host and the first chip may respectively generate a random number as their own temporary private key. Also, the host and the first chip may respectively calculate their own public key according to an asymmetric encryption algorithm and their own temporary private key. Also, the host and the first chip may exchange public keys. Also, the host and the first chip can obtain their respective temporary shared keys according to a key exchange algorithm corresponding to the asymmetric encryption algorithm, the other party's public key, and their own temporary private key. In particular embodiments, the temporary shared key of the host and the temporary shared key of the first chip can be equal. In particular embodiments, in the key exchange phase, the asymmetric encryption algorithm may be configured as the ECC algorithm, and the key exchange algorithm corresponding to the asymmetric encryption algorithm can be configured as the ECDH algorithm.

At step 41, the host can convert a first signal into a first ciphertext according to a symmetric encryption algorithm and the temporary shared key, and may send the first ciphertext to the first chip, where the first signal can be a signal generated based on a random number and a plaintext including a first command. In particular embodiments, the symmetric encryption algorithm can be configured as the AES algorithm.

The host can concatenate the random number and the plaintext including the first command to generate a second signal, use a checksum algorithm to calculate the second signal to generate a third signal, and concatenate the second signal and the third signal to generate the first signal. In particular embodiments, the checksum algorithm can be configured as the CRC16 algorithm. Optionally, the checksum algorithm can be any suitable algorithm (e.g., the MD3 or MD5 algorithm, etc.).

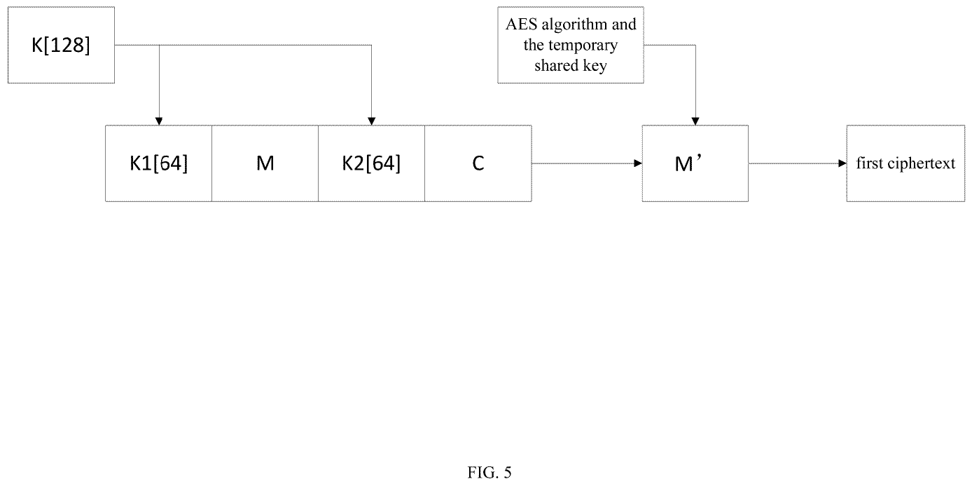

Referring now to FIG. 5, shown is a schematic block diagram of an example method for generating a first ciphertext, in accordance with embodiments of the present invention. In this particular example, the host can generate a 128-bit random number K[128], splits the random number K[128] into a first 64-bit data segment K1[64] and a last 64-bit data segment K2[64]. The host may perform a first concatenation of plaintext M including the first command and the split random number according to a preset format to generate second signal M1, where M1 is equal to K1[64]|M|K2[64]. The host may use the CRC16 algorithm to calculate second signal M1 to ensure information integrity, generating third signal C. The host may concatenate third signal C to the end of second signal M1 to generate first signal M′=M1|C. Subsequently, the host may use the AES algorithm and the temporary shared key to convert the first signal into the first ciphertext.

At step 42, the first chip may receive the first ciphertext, convert the first ciphertext into the plaintext including the first command according to the symmetric encryption algorithm and the temporary shared key, and the first chip can execute the first command to enter the first operating mode. In particular embodiments, the symmetric encryption algorithm can be configured as the AES algorithm.

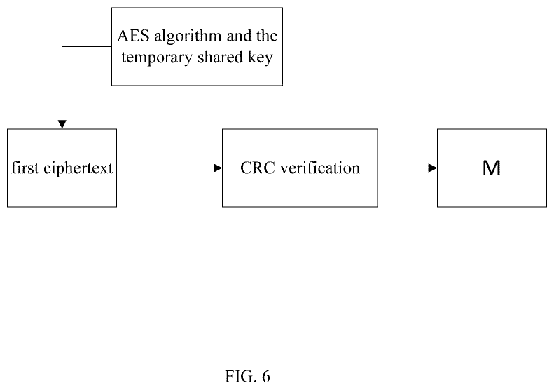

Referring now to FIG. 6, shown is a schematic block diagram of an example method for decrypting a first ciphertext, in accordance with embodiments of the present invention. In this particular example, the first chip may receive the first ciphertext, can convert the first ciphertext using the AES algorithm and the temporary shared key, then may perform CRC verification, to generate the plaintext M including the first command.

It should be noted that FIGS. 5 and 6 illustrate the generation and decryption process of the first ciphertext merely as an example of particular embodiments. In this particular example, only the first command is encrypted. In other examples, the second command may also be encrypted. The battery protection method of particular embodiments may not only prevent illegitimate batteries formed by replacing only the battery cell of the battery unit from being misjudged as legitimate batteries, but also can prevent illegitimate batteries where the entire battery unit is replaced from being misjudged as legitimate batteries.

In particular embodiments, during identity authentication, based on the ECC (e.g., Elliptic curve cryptography) algorithm, the digital signature ECDSA (e.g., Elliptic curve digital signature algorithm) algorithm can be used to implement signing and verification. In particular embodiments, through a random number challenge initiated by the host, the first chip may sign the random number, and the host can acquire the signature result and verifies it, thereby proving that the first chip is officially certified. The adopted ECC algorithm can be more secure than the previously used SHA256 algorithm. After the host confirms through identity authentication that the first chip is officially certified, the host may wish to make the first chip enter the first operating mode to change the battery-related information in the first chip. In conventional approaches, communication commands and information between the host and the first chip are typically exposed in plaintext on the communication cables, making communication commands and information easy for third parties to acquire and forge.

Therefore, particular embodiments also implement information encryption. A temporary key can be generated through the ECDH (e.g., Elliptic curve Diffie-Hellman) algorithm, which can reduce the workload of chip key management. Then, a symmetric encryption algorithm, such as AES (e.g., Advanced encryption standard), can be used to quickly encrypt and decrypt communication commands and information. Simultaneously, in order to ensure that the same plaintext produces different ciphertext, a random number can be introduced into the plaintext before using the AES algorithm for encryption. The combined use of the ECDH key exchange algorithm and the salted symmetric encryption algorithm means that even the same effective plaintext may produce different ciphertexts, e.g., the communication information or commands transmitted on the communication line are different each time. This can effectively hinder replay attacks, can greatly increase the difficulty of cracking, and thus improve security. It should be noted that the random number challenge, random number key, and random number salt can rely on hardware true randomness, and otherwise they can be relatively easily cracked.

In particular embodiments, using the ECC public key encryption algorithm can improve the security of identity authentication. By encrypting at least the commands sent from the host to the first chip, the first command itself may be protected from being directly acquired, further protecting the battery-related information in the first chip from being altered, such as the battery charge-discharge cycle count and battery health information. This can increase the difficulty for third parties to crack and hinder the introduction of unofficial batteries.

In one embodiment, implementing information encryption may require adding extra modules inside the first chip (e.g., an ECDSA algorithm module, an ECDH algorithm module, an AES algorithm module, etc.). These additionally added modules can be integrated inside the first chip, thus reducing the extra cost of dedicated chips. Whether proving the legitimacy of the first chip or protecting its data from tampering, integration into a single chip can be more conducive to protecting the first chip itself and increasing the security of this solution.

In particular embodiments, each time the host needs to request the first chip to enter the first operating mode, information encryption may be required. For example, the host generates the first ciphertext and sends it to the first chip, thereby encrypting the transmission of the plaintext including the first command. In particular embodiments, each time the system is powered on or restarted, it can be necessary to determine whether the first chip in the battery unit matches the host. In particular embodiments, the first chip can exit the first operating mode and enter the second operating mode after operating in the first operating mode for a first period of time, e.g., after lingering in this mode for too long. In particular embodiments, in the first operating mode, if neither the host nor the first chip sends or receives information for the first period of time, e.g., if the communication line is inactive for a long time, the first chip can exit the first operating mode and enter the second operating mode.

Particular embodiments may also provide a battery system that can include a host and a battery unit. For example, the battery system may use any one of the battery unit protection methods of particular embodiments to protect its own battery unit, to prevent the entire battery unit from being illegally replaced or the battery cell within the battery unit from being illegally replaced, e.g., to create an obstacle for illegal replacement of the entire battery unit or the battery cell within the battery unit.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A method of battery unit protection, and when a first chip in a battery unit matches with a host, the method comprises:
a) converting by the host, a first signal into a first ciphertext according to a symmetric encryption algorithm and a temporary shared key;
b) sending, by the host, the first ciphertext to the first chip, wherein the first signal is configured as a signal generated based on a random number and a plaintext comprising a first command;
c) receiving, by the first chip, the first ciphertext;
d) converting, by the first chip, the first ciphertext into the plaintext comprising the first command according to the symmetric encryption algorithm and the temporary shared key; and
e) executing, by the first chip, the first command to enter a first operating mode.

2. The method of claim 1, further comprising:
a) concatenating, by the host, the random number and the plaintext comprising the first command to generate a second signal;
b) using, by the host, a checksum algorithm to calculate the second signal to generate a third signal; and
c) concatenating, by the host, the second signal and the third signal to generate the first signal.

3. The method of claim 1, wherein each time a request for the first chip to enter the first operating mode is needed, the host generates the first ciphertext and sends the first ciphertext to the first chip, in order to encrypt and transmit the plaintext comprising the first command.

4. The method of claim 1, further comprising:
a) generating, respectively by the host and the first chip, a random number as their own temporary private key;
b) calculating, by the host and the first chip respectively, their own public key according to an asymmetric encryption algorithm and their own temporary private key;
c) exchanging, by the host and the first chip, the public keys; and
d) obtaining, by the host and the first chip respectively, their own temporary shared key according to a key exchange algorithm corresponding to the asymmetric encryption algorithm, the other party's public key, and their own temporary private key.

5. The method of claim 1, further comprising determining whether the first chip matches with the host according to a digital signature algorithm based on an asymmetric encryption algorithm.

6. The method of claim 5, wherein the determining whether the first chip in the battery unit matches with the host is performed each time a battery system is powered on or restarted.

7. The method of claim 5, wherein the determining whether the first chip matches with the host according to a digital signature algorithm based on an asymmetric encryption algorithm comprises:
a) acquiring, by the host, a public key of the first chip from a certificate of the first chip;
b) generating, by the host, a random number and sending, by the host, the random number to the first chip;
c) signing, by the first chip, the received random number according to a private key of the first chip and the digital signature algorithm based on the asymmetric encryption algorithm to generate a first result, and sending, by the first chip, the first result to the host; and
d) verifying, by the host, the signature of the received first result according to the public key of the first chip and the digital signature algorithm based on the asymmetric encryption algorithm, in order to determine whether the first chip in the battery unit matches with the host.

8. The method of claim 7, wherein the acquiring, by the host, a public key of the first chip from a certificate of the first chip comprises:
a) sending, by the host, a command to the first chip to acquire the certificate; sending, by the first chip, the certificate of the first chip to the host;
b) verifying, by the host, the certificate according to a public key of the host and the digital signature algorithm based on the asymmetric encryption algorithm; and
c) wherein if the verification is successful, acquiring the public key of the first chip from the certificate.

9. The method of claim 1, wherein the first chip exits the first operating mode to enter a second operating mode after operating in the first operating mode for a first time period.

10. The method of claim 1, wherein in the first operating mode, if neither the host nor the first chip sends or receives information in a first time period, the first chip exits the first operating mode to enter a second operating mode.

11. A battery system, comprising a host and a battery unit, wherein the battery system protects the battery unit using the method of claim 1.
